(19) United States
(12) Patent Application Publication
(10) Pub. No.: US 2007/0087191 A1
(43) Pub. Date: Apr. 19, 2007

(54) Shrink label for pet bottle and pet bottle with the label attached thereto

(75) Inventors: Takuji Kaya, Tokyo (JP); Yoshikazu Kakura, Osaka (JP); Hiroko Yuminaga, Osaka (JP); Shingo Amaki, Kanagawa (JP); Keiji Inomata, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: FUJI SEAL INTERNATIONAL, INC., Osaka-shi (JP); KANSAI PAINT CO., LTD., Amagasaki-shi (JP)

(21) Appl. No.: 10/578,777

(22) PCT Filed: Nov. 11, 2004
(86) PCT No.: PCT/JP04/16729

§ 371 Date: May 9, 2006

(30) Foreign Application Priority Data
Nov. 12, 2003 (JP) 2003-382592

(51) Int. Cl. B32B 7/00

(52) U.S. Cl. 428/343

(57) ABSTRACT

The present invention provides a shrink label for a PET bottle comprising a heat-shrinkable film, wherein the shrink label has an adhesive coating film layer of a coating agent (A) on the side contacting the PET bottle, the adhesive coating film layer having a dry film thickness of 0.1 to 10 μm; and the peel strength after keeping the coating film surface of the shrink label and a PET film in pressure contact with each other at a pressure of 8.5 MPa in a 40° C. atmosphere for 24 hours is within the range of 5 mN/50 mm to 17 N/50 mm. The invention also provides a PET bottle having the shrink label attached thereto.

### TECHNICAL FIELD

The present invention relates to a shrink label for PET bottles and a PET bottle with the label attached thereto.

### BACKGROUND ART

In recent years, being used in vast numbers, PET bottles have replaced metal cans in the fields of drink containers, etc.

PET bottles are blow-molded bottles whose principal component is polyethylene terephthalate. Shrink labels with a trade name, etc. printed on the inner surface thereof are usually attached to the exterior of such PET bottles. In order to facilitate PET bottle recycling, such shrink labels are required to be readily removable. For example, Japanese Unexamined Patent Publication No. 2002-326638 discloses a shrink label that is perforated so as to be readily removable.

The above-mentioned printing on the inner surface of a shrink label provides various designs for products as well as the pieces of information that consumers need, such as trade name, contents, seller, and precautions. This printed surface is dry and unadhesive so as to make the label readily removable. Moreover, in order to make the label readily removable, bonding agents or adhesives are usually not applied to the inner side of the shrink label.

There is a recent trend for PET bottles to be thin-walled so as to cut down costs and to reduce weight. Such thin-walled PET bottles are easily subject to deformation due to changes in bottle internal pressure, external pressure on the bottle, etc. Problems that arise are, for example, bottle deformation in drink-filling lines, bottle deformation during product distribution, etc. Furthermore, there is a problem of drink-filled PET bottles that lie piled up in a vending machine being deformed and, as a result, getting stuck in the vending machine or causing two PET bottles to be dispensed at once.

In order to prevent deformation, PET bottles have been designed to be in the form of a prism such as a hexagonal prism or to have sunken portions in the circumferential direction, etc. However, the deformation of PET bottles cannot be thereby sufficiently prevented.

### DISCLOSURE OF THE INVENTION

Problem to be Solved by the Invention

An object of the present invention is to provide a shrink label for PET bottles that is capable of preventing deformation of PET bottles, and a PET bottle with the shrink label that does not readily deform.

Means for Solving the Problem

In order to achieve the above object, the present inventors conducted extensive research. As a result, the inventors have found that, by forming an adhesive coating film layer with specific peel strength on the inner side of a shrink label, the label can be easily removed at the time of PET bottle recycling; blocking can be prevented while storing label rolls; and remarkable effects can be achieved in the prevention of PET bottle deformation. Based on such findings, the inventors have accomplished the present invention.

The present invention provides the following shrink labels for PET bottles, and PET bottles using the labels.

1. A shrink label for a PET bottle comprising a heat-shrinkable film, wherein the shrink label has an adhesive coating film layer of a coating agent (A) on the side contacting the PET bottle, the adhesive coating film layer having a dry film thickness of 0.1 to 10 μm; and the peel strength after keeping the coating film surface of the shrink label and a PET film in pressure contact with each other at a pressure of 8.5 MPa in a 40° C. atmosphere for 24 hours is within the range of 5 mN/50 mm to 17 N/50 mm.

2. A shrink label according to item 1, wherein the shrink label is for a PET bottle having a plurality of alternately projecting and sunken portions in the circumferential direction; and the shrink label having the adhesive coating film layer of the coating agent (A) on the side contacting the PET bottle, the adhesive coating film layer being provided on at least the portions contacting the projecting portions of the PET bottle.

3. A shrink label according to item 1, wherein the heat-shrinkable film comprises a polyester resin, polystyrene resin, polyolefin resin, or polyvinyl chloride resin.

4. A shrink label according to item 1, wherein the heat-shrinkable film has a thickness of 10 to 100 μm and a shrinkage stress of at least 2.0 N/cm in the main shrinkage direction.

5. A shrink label according to item 1, wherein the coating agent (A) comprises an organic resin (a) having a number average molecular weight of 500 to 100,000 and a softening point of 30° C. to 150° C.

6. A shrink label according to item 5, wherein the organic resin (a) is at least one resin selected from the group consisting of epoxy resins, acrylic resins, ethylene vinyl acetate resins, polyester resins, urethane resins, and terpene resins.

7. A shrink label according to item 5, wherein the coating agent (A) further comprises a pigment (b).

8. A shrink label according to item 7, wherein the pigment (b) is titanium oxide and/or aluminum powder.

9. A shrink label according to item 1, wherein the coating film of the coating agent (A) is formed by gravure coating.

10. A shrink label according to item 9, wherein, at the time of gravure coating, the coating agent (A) has a solids content of 20% to 80% by weight and a viscosity of 5 to 60 seconds/Zahn cup #3.

11. A shrink label according to item 1, wherein the peel strength after keeping the coating film surface of the coating agent (A) and the PET film in pressure contact with each other at a pressure of 8.5 MPa in a 40° C. atmosphere for 24 hours is within the range of 10 mN/50 mm to 4 N/50 mm.

12. A shrink label according to item 11, wherein the peel strength after keeping the coating film surface of the coating agent (A) and the PET film in pressure contact with each other at a pressure of 8.5 MPa in a 40° C. atmosphere for 24 hours is within the range of 50 mN/50 mm to 1 N/50 mm.

13. A PET bottle having a shrink label according to item 1 attached thereto.

Shrink Label for PET Bottles

The shrink label for PET bottles of the present invention has an adhesive coating film layer of a coating agent (A) on the inner side of a heat-shrinkable film that forms the label, that is, on the side contacting a PET bottle, the adhesive coating film layer having a dry film thickness of 0.1 to 10 μm, and preferably 0.5 to 5 μm. On the inner side of the heat-shrinkable film that forms the shrink label, a trade name and other pieces of information are usually printed beforehand, and the coating agent (A) is applied to the printed surface.

The adhesive strength indicated by the peel strength after keeping the coating film surface of coating agent (A) of the shrink label and a PET film in pressure contact with each other at a pressure of 8.5 MPa in a 40° C. atmosphere for 24 hours is within the range of 5 mN/50 mm to 17 N/50 mm.

The above peel strength can be obtained by keeping the shrink label to be measured and a PET film intended for such a PET bottle in pressure contact with each other at a pressure of 8.5 MPa in a 40° C. atmosphere for 24 hours, leaving them at 20° C. for at least 1 hour, cutting the pressure contact-bonded shrink label coating film surface and PET film to a 50 mm width, and measuring the peel strength (mN/50 mm) when peeling the shrink label at 180 degrees at a pulling speed of 200 mm/min.

In the present invention, in order to obtain excellent properties in removability, blocking resistance, and PET bottle deformation prevention effects, the peel strength measured in this manner must be within the range of about 5 mN/50 mm to about 17 N/50 mm. The peel strength is preferably within the range of about 10 mN/50 mm to about 4 N/50 mm, more preferably within the range of about 50 mN/50 mm to about 1 N/50 mm, and even more preferably within the range of about 100 mN/50 mm to about 500 mN/50 mm.

From the viewpoint of environmental protection, PET bottle recyclability is regarded as important, and it is desired that a shrink label attached to a PET bottle have high removability, that is, the label can be easily removed at the time of recycling, and that bonding agents and the like do not remain after the removal of the label. Therefore, it is important to adjust the adhesive strength of the shrink label so that it is not too high. The shrink label of the present invention sufficiently meets such requirements.

Furthermore, since shrink labels are produced in cylindrical shapes, folded into flattened shapes, and opened for attachment to bottles, etc., it is important for a shrink label to have excellent blocking resistance, so that the inner side surface of a cylindrical label does not undergo blocking due to adhesion. The shrink label of the invention also meets this requirement.

Materials for Shrink Label

Materials that are typically used for PET bottle shrink labels can be used for the heat-shrinkable film of the shrink label of the present invention without limitation. Examples of materials for the heat-shrinkable film include polyester resins, polystyrene resins, polyolefin resins, polyvinyl chloride resins, etc.

Examples of polyester resins include polyethylene terephthalate (PET), polybutylene terephthalate (PBT), polyethylene naphthalate (PEN), etc. Examples of polystyrene resins include polystyrene, styrene-butadiene copolymer, etc. Examples of polyolefin resins include linear polyolefins such as polyethylene and polypropylene; amorphous cyclic polyolefins; etc. Examples of polyvinyl chloride resins include vinyl chloride homopolymers; copolymers of vinyl chloride with vinyl acetate, ethylene, styrene, acrylonitrile, acrylic esters, methacrylic esters, etc.

Preferable heat-shrinkable films are those comprising polystyrene resins such as styrene-butadiene copolymers, polyester resins such as PET, etc., in that they provide a high shrinkage percentage of at least 40% at a low temperature of about 80° C., for example.

Such heat-shrinkable films are preferably those obtained by melting/extruding an above-mentioned resin to form sheets and then stretching the sheets to about 2 to about 6 times the original length in at least one direction (for example, in the transverse direction) at a temperature of about 70° C. to about 100° C. Such heat-shrinkable films preferably have a heat shrinkage percentage of at least about 50%, and more preferably a heat shrinkage percentage of about 60% to about 85%, in the main stretching direction (for example, in the transverse direction). When the main stretching direction is the transverse direction, the heat shrinkage percentage in the machine direction is preferably about 0% to about 20%. Here, the transverse direction means a direction of approximately 90 degrees to the direction of taking the sheet. The heat shrinkage percentage means the shrinkage percentage when the film is soaked in 95° C. hot water for 10 seconds.

A heat-shrinkable film having a thickness of about 10 to about 100 μm can be used. However, in order to provide strong heat shrinkage force (shrinkage stress) for close contact with a PET bottle and to reduce costs, the heat-shrinkable film preferably has a thickness of about 20 to about 80 μm, and more preferably a thickness of about 30 to about 70 μm.

Heat-shrinkable films comprising polyester resins are preferable in that they provide strong shrinkage stress. The heat-shrinkable film preferably has a shrinkage stress of at least 2.0 N/cm (at least 4.0 MPa in the case of a film having a thickness of 50 μm) in the main shrinkage direction (for example, in the transverse direction), and more preferably at least 4.0 N/cm (at least 8.0 MPa in the case of a film having a thickness of 50 μm). Here, shrinkage stress means a value obtained by setting a film piece cut to the width of 15 mm between tensile tester chucks, with the distance between the chucks being 50 mm, soaking it in 95° C. hot water for 10 seconds, taking it out, and, after 3 minutes, measuring the stress in the main shrinkage direction.

Coating Agent (A)

Coating agent (A) is applied to the surface of the above-described shrink label on the side contacting a PET bottle. The surface of the shrink label on the side contacting the PET bottle is usually wholly or partially printed. When the surface of the shrink label on the side contacting the PET bottle is printed, coating agent (A) must be applied over the printed surface.

Although the coating agent is preferably applied over approximately the entire surface of the inner side of the shrink label, it may be applied thereto only partially. When the coating agent is partially applied, it is preferably applied in the form of a band in the circumferential direction of the PET bottle.

When the PET bottle has a plurality of alternately projecting and sunken portions in the circumferential direction, it is preferable to apply coating agent (A), on the side contacting the PET bottle, at least to those portions of the shrink label contacting the projecting portions of the PET bottle.

In the present invention, coating agent (A) comprises an organic resin (a) as an essential component and may optionally contain additives such as pigments (b), viscosity regulators, dispersants, defoaming agents, leveling agents, waxes, etc.

The organic resin (a) preferably has a number average molecular weight of about 500 to about 100,000, and more preferably about 800 to about 50,000. An organic resin (a) having a number average molecular weight of less than 500 is undesirable in that the cohesive force of a coating film obtained from the coating agent (A) is weakened, resulting in decreased peel strength. An organic resin (a) having a number average molecular weight of more than 100,000 is undesirable in that the cohesive force becomes too strong, causing the shrink label to curl.

Being heated when attaching the shrink label to a PET bottle, the organic resin (a) softens, imparting an adhesive property. Therefore, the organic resin (a) preferably has a softening point of about 30° C. to about 150° C. The organic resin (a) more preferably has a softening point of about 50° C. to about 140° C. An organic resin (a) having a softening point below 30° C. has decreased resistance to blocking. An organic resin (a) having a softening point above 150° C. has decreased adhesive strength between the shrink label and PET bottle, and the intended effect of preventing PET bottle deformation may not be acquired.

Examples of organic resins (a) include epoxy resins, acrylic resins, ethylene vinyl acetate resins, polyester resins, urethane resins, terpene resins, polyolefin resins, polyamide resins, gum resins, etc. Modified resins of such resins, such as hydrogenated resins, may be used. Organic resins may be used singly or in combination of two or more. Among such organic resins, epoxy resins, acrylic resins, ethylene vinyl acetate resins, polyester resins, urethane resins, and terpene resins are especially suitable, as they allow peel strength to be easily adjusted to within the range required in the present invention.

Examples of pigments (b) include color pigments such as titanium oxide, zinc white, carbon black, red iron oxide, quinacridone red, phthalocyanine blue, and phthalocyanine green; extender pigments such as baryta powder, clay, and silica; luster pigments such as aluminum powder and metal oxide-coated mica powder; etc. Pigment (b) is used in order to enhance the color effect of the shrink label and to adjust the adhesive strength of the coating film of coating agent (A) to the PET bottle. To enhance color effect, color pigments and luster pigments are suitable, and titanium oxide, aluminum powder, etc. are especially preferable.

Viscosity regulators are optionally used to adjust the viscosity of coating agents, and examples thereof include organic solvents, water, etc. Preferable organic solvents are those that dissolve organic resins (a) well and, in a drying step after coating, vaporize easily. Examples of such organic solvents include hydrocarbon solvents such as hexane, toluene, xylene, and petroleum naphtha; alcohol solvents such as ethanol, isopropanol, and n-butanol; ketone solvents such as acetone and methyl ethyl ketone; ester solvents such as ethyl acetate and butyl acetate; ether solvents such as ethylene glycol monobutyl ether; etc. When organic resin (a) is a water-soluble or water-dispersible resin, water and, optionally, organic solvents that dissolve in water can be used.

Examples of dispersants include polyvinyl alcohols, etc.

When a heat-shrinkable film has a printed surface, coating agent (A) is applied over the printed surface. Preferable coaters are such as are used when applying adhesives to films, etc. Examples of such coaters include gravure roll coaters (gravure printing machines), etc. In particular, the use of gravure printing machines enhances efficiency in that they can successively perform printing of characters, designs, etc. and application of coating agents. The use of gravure printing machines enables application of coating agents to the intended portions without waste.

When gravure roll coaters are used for application, a suitable viscosity of coating agent (A) is about 5 to about 60 seconds/Zahn cup #3, and, in particular, about 10 to about 40 seconds/Zahn cup #3. In view of coating suitability, the coating agent (A) preferably has a solids content of about 20% to about 80% by weight, and, in particular, about 30% to about 60% by weight.

In the present specification, the viscosity by Zahn viscosity cup indicates a value obtained according to the measurement method as defined in ASTM D 1084-97.

After coating agent (A) is applied over a heat-shrinkable film, the applied coat is usually dried by hot air, and the heat-shrinkable film is rolled up. Drying conditions are about 50° C. to about 150° C. for about 0.1 to about 1 minute, and the coating film obtained by drying has a thickness of about 0.1 to about 10 μm, and preferably about 0.5 to about 5 μm.

The obtained roll film is suitably slit in a predetermined width and made cylindrical, with the coating agent-applied side being the inner side, by adhesive sealing with organic solvent or adhesive applied to the side edge or by heat sealing. The cylindrical film is then folded into a flattened shape and rolled up.

At the time of use, the cylindrical film is unrolled, cut to a predetermined size (length) to be in the form of a shrink label, and thereafter opened into a cylindrical shape to cover a PET bottle, and subjected to heat shrinkage for attachment to the PET bottle. The shrink label may be positioned so as to cover approximately the entire length of the PET bottle or only part of the PET bottle body (preferably, more than half of the entire length).

PET Bottle

The PET bottle to which the shrink label is attached may be a bottle obtained by blow molding of polyethylene terephthalate or a thermoplastic resin containing polyethylene terephthalate as the principal component. Examples of thermoplastic resins containing polyethylene terephthalate as the principal component include copolymers of polyethylene terephthalate with polyethylene naphthalate, etc. The bottle obtained by blow molding may be single-layered or multilayered.

The form of the PET bottle is preferably such that the PET bottle has a plurality of convex portions, or projecting portions, and a plurality of concave portions, or sunken portions, alternately in the circumferential direction in the bottle body's cross-section; and that the PET bottle has a roughly polygonal cross-section so as to form gaps between the PET bottle and the shrink label attached thereto. When the PET bottle has such a polygonal section, deformation due to changes in bottle internal pressure can be prevented by the concave portions, or sunken portions, while deformation due to external pressure on the bottle can be prevented by making the PET bottle convex portions and the shrink label difficult to slip at the portions of contact therebetween.

The heat shrinkage of the shrink label can be performed using known heaters such as steam heaters, hot air heaters, etc. When using a steam heater, a shrink label can be shrunk by being passed through a steam heater (tunnel) set at 75° C. to 90° C. for about 3 to about 10 seconds.

In the above-described manner, a PET bottle with the PET bottle shrink label of the present invention attached thereto, which does not readily deform, can be obtained. Such PET bottles with a label attached thereto are suitable for use as containers for drinks such as alcoholic drinks, juices, water, and teas; seasonings/flavorings such as soy sauce, mirin (sweet sake), noodle soups, and oils; liquid detergents such as shampoos; etc. Examples of alcoholic drinks include beer, sake, wine, etc.

FIGS. 1 and 2 show an example of a PET bottle with the shrink label of the present invention attached thereto. FIG. 1 is a front view of a PET bottle with the shrink label attached thereto. FIG. 2(i) is a sectional view along the line A-A in FIG. 1, while FIG. 2(ii) is a partially enlarged view of FIG. 2(i).

In FIGS. 1 and 2, PET bottle main body 1 has a cylindrical body; and a shrink label 2 is attached over the external surface of the cylindrical body in a cylindrical form, the shrink label 2 comprising a printed heat-shrinkable film 6 and an adhesive coating film layer 3 formed on the inner side of the heat-shrinkable film. The cross-section of the bottle body has a polygonal form (a hexagonal form in the present figure), composed of convex portions 4 and concave portions 5 of the body, each concave portion 5 being between convex portions 4. The concave portions 5 are curved, sunken in the radial inward direction. The shrink label 2 is in contact with only the convex portions 4, and not in contact with the concave portions 5, so as to form gaps. The adhesive coating film layer 3 on the inner side of the shrink label 2, which is formed of a coating agent (A), keeps the coating film layer 3 in close contact with the convex portions 4 at the portions of contact therebetween to make them difficult to slip, thereby inhibiting deformation of the PET bottle.

### EFFECT OF THE INVENTION

The present invention provides the following extremely remarkable effects by forming, on the inner side of a PET bottle shrink label, an adhesive coating film layer of moderately low adhesive strength having a peel strength of 5 mN/50 mm to 17 N/50 mm.

(1) If a force acts so as to deform a PET bottle, since the above adhesive strength allows the surface of the PET bottle and the inner surface of the shrink label to be in close contact with each other, slippage between the bottle surface and the label inner surface can be inhibited, thereby achieving remarkable effects in the prevention of PET bottle deformation.

Such remarkable effects in deformation prevention can be achieved in thin-walled PET bottles such as a 500 ml capacity bottle having a weight of no more than about 23 g.

(2) Since the above adhesive strength is moderately low, the label can be easily removed when recycling the PET bottle.

(3) The above adhesive strength is moderately low; therefore, when storing a heat-shrinkable film that has been rolled up after forming an adhesive coating film layer of coating agent (A) on the inner side of the heat-shrinkable film forming a shrink label, the coating film surface of coating agent (A) and the outer surface of the heat-shrinkable film do not cause blocking by sticking together. Furthermore, when a shrink label produced in a cylindrical shape and folded into a flattened shape is opened for attachment to a bottle, etc., poor opening due to blocking does not occur, since the inner side surface of the label does not cause blocking by sticking together. Thus the shrink label of the present invention has excellent resistance to blocking.

### BRIEF DESCRIPTION OF THE DRAWINGS

FIG. 1 is a front view of a PET bottle with the shrink label of the present invention attached thereto.

FIG. 2(i) is a sectional view along the line A-A in FIG. 1; and FIG. 2(ii) is a partially enlarged view of FIG. 2(i).

FIG. 3 shows an outline of PET bottle deformability measurement.

### REFERENCE NUMERALS

1 PET bottle main body

2 shrink label

3 adhesive coating film layer

4 convex portions of PET bottle body

5 concave portions of PET bottle body

6 heat-shrinkable film

### BEST MODE FOR CARRYING OUT THE INVENTION

The present invention is described below in more detail with reference to Synthesis Examples, Examples, and Comparative Examples. In these examples, parts and percentages are expressed on a weight basis.

### SYNTHESIS EXAMPLE 1

### Synthesis of Epoxy Resin

Two hundred parts of bisphenol-A liquid epoxy resin (trade name: “Epikote 828”, product of Japan Epoxy Resin Co., Ltd.), 85.2 parts of bisphenol A, 0.2 parts of 50% aqueous tetramethylammonium chloride solution, and 15 parts of methyl ethyl ketone were placed in a reaction chamber, heated to 140° C. with stirring, and maintained at this temperature for 3 hours, giving epoxy resin A1. The resin had a solids content of 95%, a number average molecular weight of about 1,600, and a softening point of about 95° C.

### SYNTHESIS EXAMPLE 2

### Synthesis of Polyester Resin

Using a standard polyester resin production device equipped with a heater, a stirrer, a reflux condenser, a water separator, a rectification column, a thermometer, etc., 70.55 parts of terephthalic acid, 93.79 parts of isophthalic acid, 1.46 parts of adipic acid, 61.38 parts of ethylene glycol, and 10.50 parts of neopentyl glycol were placed in a reaction chamber and heated. After the materials had melted, stirring was initiated, and the reaction temperature was raised to 230° C. and maintained at 230° C. for 2 hours. The generated condensation water was distilled off from the system through the rectification column. Subsequently, 9 parts of xylene was added to the contents of the reaction chamber, and the reaction, which was converted to a solvent condensation method, was allowed to continue. When the acid value reached 3 mg KOH/g, the reaction was terminated. The mixture was cooled while the xylene was distilled off under reduced pressure, thus giving polyester resin B1. The resin had a solids content of 95.7%, a softening point of 56° C., and a number average molecular weight of about 2,000.

### SYNTHESIS EXAMPLE 3

### Synthesis of Urethane Resin

Using a standard resin reactor equipped with a heater, a stirrer, a reflux condenser, a thermometer, etc., 1,000 parts of polycarbonate diol (trade name: “L-6001”, product of Asahi Kasei Corporation), 315 parts of neopentyl glycol, and 990 parts of methyl ethyl ketone were placed in a reaction chamber and heated to 80° C. After the materials had melted, 667 parts of 3-isocyanatomethyl-3,5,5′-trimethylcyclohexylisocyanate (IPDI) was added dropwise over 30 minutes with stirring, and the mixture was further maintained at 80° C. while the reaction was allowed to continue until substantially all the isocyanate had disappeared. Thus a solution of urethane resin C1 with a solids content of 66.7% was obtained. The urethane resin C1 had a softening point of 102° C. and a number average molecular weight of about 2,000.

### SYNTHESIS EXAMPLE 4

### Synthesis of Acrylic Resin

Ethyl acetate (253.5 parts) was placed in a four-necked flask equipped with a thermometer, a stirrer, and a cooling tube, and heated to 75° C. under a nitrogen gas atmosphere. While maintaining the contents of the flask at this temperature, a monomer/initiator mixed liquid of 150 parts of methyl methacrylate, 350 parts of n-butyl methacrylate, and 5 parts of 2,2′-azobis(isobutyronitrile) was added dropwise over 4 hours. After completion of the dropwise addition, the mixture was stirred at the same temperature for 1 hour, and a mixed solution of 2.5 parts of 2,2′-azobis(isobutyronitrile) and 50 parts of ethyl acetate was added dropwise at this temperature over 1 hour. After completion of the dropwise addition, 183.5 parts of ethyl acetate was added to the mixture and stirred at the same temperature for 2 hours. Thus a solution of acrylic resin E1 with a solids content of 50% was obtained. The acrylic resin E1 had a softening point of about 85° C. and a number average molecular weight of about 9,800.

### SYNTHESIS EXAMPLE 5

### Synthesis of Acrylic Resin

A solution of acrylic resin E2 with a solids content of 50% was obtained in the same manner as in Synthesis Example 4, except that a monomer/initiator mixed solution of 130 parts of methyl methacrylate, 356 parts of n-butyl methacrylate, 14 parts of acrylic acid, and 5 parts of 2,2′-azobis(isobutyronitrile) was used in place of the monomer/initiator mixed solution of Synthesis Example 4. The acrylic resin E2 had a softening point of about 85° C. and a number average molecular weight of about 12,000.

### SYNTHETIC EXAMPLE 6

### Synthesis of Acrylic Resin

A solution of acrylic resin E3 with a solids content of 50% was obtained in the same manner as in Synthesis Example 4, except that a monomer/initiator mixed solution of 130 parts of methyl methacrylate, 345 parts of n-butyl methacrylate, 25 parts of 2-hydroxyethyl methacrylate, and 5 parts of 2,2′-azobis(isobutyronitrile) was used in place of the monomer/initiator mixed solution of Synthesis Example 4. The acrylic resin E3 had a softening point of about 85° C. and a number average molecular weight of about 12,000.

### SYNTHETIC EXAMPLE 7

### Synthesis of Acrylic Resin

A solution of acrylic resin E4 with a solids content of 50% was obtained in the same manner as in Synthesis Example 4, except that a monomer/initiator mixed solution of 130 parts of methyl methacrylate, 342.5 parts of n-butyl methacrylate, 27.5 parts of glycidyl methacrylate, and 5 parts of 2,2′-azobis(isobutyronitrile) was used in place of the monomer/initiator mixed solution of Synthesis Example 4. The acrylic resin E4 had a softening point of about 85° C. and a number average molecular weight of about 11,000.

Production of Coating Agent and Performance Test

### EXAMPLE 1

In a vessel equipped with a stirrer, 31.6 parts of epoxy resin A1 of Synthetic Example 1, 34.2 parts of methyl ethyl ketone, and 34.2 parts of toluene were placed, mixed with stirring, and dissolved, thus giving a coating agent with a solids content of 30%. The coating agent had a viscosity of 12 seconds/Zahn cup #3 (25° C.).

A shrink label heat-shrinkable film (thickness: 50 μm; shrinkage stress: about 8.9 MPa; shrinkage percentage: 80%) containing polyethylene terephthalate as the principal component was printed with a trade name and other pieces of information in printing ink, using a gravure printing machine. Subsequently, using the gravure printing machine, the coating agent obtained above was applied to the heat-shrinkable film so as to have a dry film thickness of about 2 μm, followed by about 5 seconds of forced drying by hot air of 60° C. to 70° C. A test film having a coating film layer of the coating agent formed on the heat-shrinkable film to a dry film thickness of about 2 μm was thus obtained.

### EXAMPLES 2 TO 11 AND COMPARATIVE EXAMPLE 1

Test films having a coating film layer of the coating agent formed thereon with a dry film thickness of about 2 μm were obtained as in Example 1, except that the components shown in table 1 below were used for coating agents in these examples.

### EXAMPLE 12

A test film having a coating film layer of the coating agent formed thereon with a dry film thickness of about 2 μn was obtained as in Example 1, except that a film (thickness: 50 μm; shrinkage stress: about 4.6 MPa; shrinkage percentage: 60%) containing polyethylene terephthalate as the principal component was used in place of the shrink label heat-shrinkable film of Example 1.

Table 1 shows the components, solids content (part), and viscosity (second/Zahn cup #3) of each coating agent used in Examples 1 to 12 and Comparative Example 1.

TABLE 1

| | | Example | | | | | | |
|---|---|---|---|---|---|---|---|---|
| | | 1 | 2 | 3 | 4 | 5 | 6 | 7 |
| Components | Epoxy resin A1 | 31.6 | | | 15.8 | | | |
| | Polyester resin B1 | | | 15.7 | | 7.8 | 13.6 | |
| | Polyester resin B2 (*1) | | | | | | | |
| | Urethane resin C1 | | | | | | | 22.5 |
| | Terpene resin D1 (*2) | | 30 | 15 | 15 | 7.5 | 13 | 15 |
| | Acrylic resin E1 | | | | | | | |
| | Acrylic resin E2 | | | | | | | |
| | Acrylic resin E3 | | | | | | | |
| | Acrylic resin E4 | | | | | | | |
| | Methyl ethyl ketone | 34.2 | 35 | 35 | 34.2 | 35 | 35 | 27.5 |
| | Toluene | 34.2 | 35 | 34.3 | 35 | 34.7 | 32.8 | 35 |
| | Titanium white pigment (*3) | | | | | 15 | | |
| | Aluminum flake pigment (*4) | | | | | | 5.6 | |

| | | | | | | | |
|---|---|---|---|---|---|---|---|
| Solids content (%) | 30 | 30 | 30 | 30 | 30 | 30 | 30 |
| Viscosity (sec) | 12 | 11 | 11 | 11 | 13 | 11 | 12 |

| | | Example | | | | | Comp. |
|---|---|---|---|---|---|---|---|
| | | 8 | 9 | 10 | 11 | 12 | Ex. 1 |
| Components | Epoxy resin A1 | | | | | 31.6 | |
| | Polyester resin B1 | | | | | | |
| | Polyester resin B2 (*1) | | | | | | 15 |
| | Urethane resin C1 | | | | | | |
| | Terpene resin D1 (*2) | | | | | | 5 |
| | Acrylic resin E1 | 50 | | | | | |
| | Acrylic resin E2 | | 50 | | | | |
| | Acrylic resin E3 | | | 50 | | | |
| | Acrylic resin E4 | | | | 50 | | |
| | Methyl ethyl ketone | 25 | 25 | 25 | 25 | 34.2 | 40 |
| | Toluene | 25 | 25 | 25 | 25 | 34.2 | 40 |
| | Titanium white pigment (*3) | | | | | | |
| | Aluminum flake pigment (*4) | | | | | | |

| | | | | | | |
|---|---|---|---|---|---|---|
| Solids content (%) | 25 | 25 | 25 | 25 | 30 | 20 |
| Viscosity (sec) | 16 | 17 | 17 | 23 | 12 | 25 |

In Table 1, (*1) to (*4) indicate the following:
(*1) Polyester resin B2: trade name “Elitel UE 3220”, product of Unitika Ltd., softening point: 120° C., number average molecular weight: about 25,000
(*2) Terpene resin D1: trade name “YS polyster T-130”, product of Yasuhara Chemical Co., Ltd., softening point: about 130° C., number average molecular weight: about 900
(*3) Titanium white pigment: trade name “JR-301”, product of Tayca Corporation
(*4) Aluminum flake pigment: trade name “Alpaste 5640NS”, product of Toyo Aluminium K.K., paste luster pigment, solids content: 71%.

### EXAMPLE 13

Eighty parts of ethylene-vinyl acetate copolymer having an ethylene content of 30% (softening point: about 60° C., number average molecular weight: about 80,000), 2 parts of terpene resin D1(*2), 5 parts of paraffin wax, 8 parts of polyvinyl alcohol, 15 parts of ethylene glycol monobutyl ether, and 200 parts of water were placed in a vessel equipped with a stirrer, and mixed with stirring, thus giving a emulsion coating agent with a solids content of 30%. The coating agent had a viscosity of 15 seconds/Zahn cup #3 (25° C.).

A shrink label heat-shrinkable film (thickness: 50 μm; shrinkage stress: about 8.9 MPa; shrinkage percentage: 80%) containing polyethylene terephthalate as the principal component was printed with a trade name and other pieces of information in printing ink, using a gravure printing machine. Subsequently, using the gravure printing machine, the coating agent obtained above was applied to the heat-shrinkable film so as to have a dry film thickness of about 2 μm, followed by about 5 seconds of forced drying by hot air of 60° C. to 70° C. A test film having a coating film layer of the coating agent formed thereon to a dry film thickness of about 2 μm was thus obtained.

### COMPARATIVE EXAMPLE 2

A shrink label heat-shrinkable film (thickness: 50 μm; shrinkage stress: about 8.9 MPa; shrinkage percentage: 80%) containing polyethylene terephthalate as the principal component was printed with a trade name and other pieces of information in printing ink, using a gravure printing machine. The obtained film was used as a test film for Comparative Example 2.

Using the test films produced in the above Examples and Comparative Examples as shrink labels for PET bottles, performance tests for peel strength, deformability, and blocking resistance were carried out by the methods described below.

With respect to the test film of Comparative Example 2, similar performance tests were carried out, using the printed surface in place of a coating agent-coated surface.

Peel strength: The test coated film was placed over a 25 μm-thick PET film (trade name: “Toyobo ester E5100”, product of Toyobo Co., Ltd., biaxially stretched polyethylene terephthalate film) intended for a PET bottle, with the coating agent-coated surface of the test coated film being on the side contacting the PET film. The PET film and the test coated film were kept in pressure contact with each other at a pressure of 8.5 MPa at 40° C. for 24 hours. The pressure contact-bonded PET film and coated film were left in a thermostatic chamber at 20° C. for 2 hours and cut to 50 mm width. At a measurement temperature of 20° C., the ends of the PET film and the coated film were held, and the films were peeled from each other in a 180 degree direction at a speed of 200 mm/min, and the peel strength (mN/50 mm) at this time was measured using a Strograph (tensile/compressive strength measurement device, product of Toyo Seiki Seisaku-sho, Ltd.).

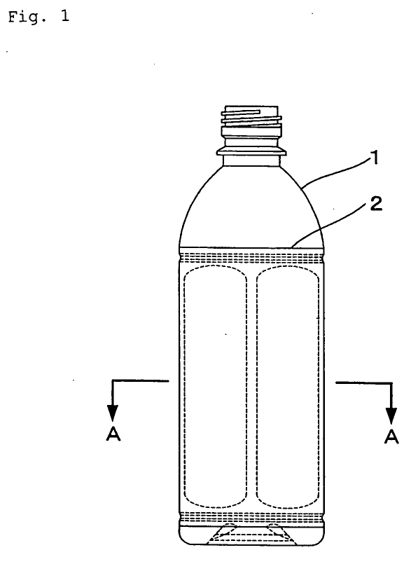

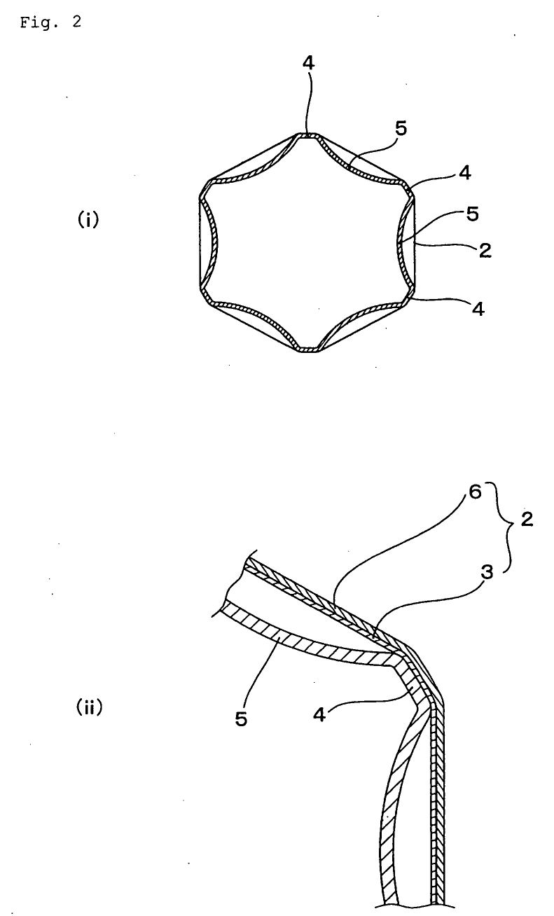

Deformability: The test coated film was made cylindrical, with the coating agent-coated surface being on the inner side, and the transverse direction (shrinkage direction) being the circumferential direction, and edges of the cylindrical film were heat-sealed, thus giving a cylindrical shrink label 130 mm in height and 215 mm in circumference. A 500 ml capacity PET bottle (bottle weight: 21 g, central bottle body portion diameter: 65 mm, the form shown in FIGS. 1 and 2) containing 500 g of water was placed inside the cylindrical label and passed through a steam tunnel of 80° C. to 90° C. to attach the shrink label to the PET bottle. A sectional view of the PET bottle with this shrink label attached thereto is shown in FIG. 2.

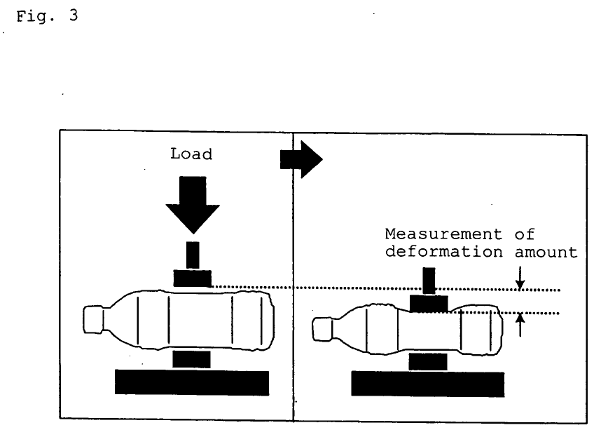

FIG. 3 shows a scheme of deformability measurement for a PET bottle with this shrink label attached thereto. As shown in FIG. 3, a PET bottle with the shrink label attached thereto was placed on the sample stand of a Strograph (tensile/compressive strength measurement device, product of Toyo Seiki Seisaku-sho, Ltd.) in a horizontal position, and the central portion of the PET bottle was sandwiched between two metal disks each with a diameter of 40 mm and a thickness of 15 mm, and pressed downward from above with a load of 40 N. The amount of deformation of the PET bottle at this time was measured using the Strograph, and the deformation percentage (%) of the PET bottle was calculated according to the following formula, and deformability was evaluated according to the criteria below.

Deformation percentage (%)=(amount of deformation/diameter of PET bottle before applying pressure)×100

Evaluation Criteria:

A: Low deformability, with a deformation percentage of less than 10%

B: Somewhat high deformability, with a deformation percentage of at least 10% but less than 15%

C: High deformability, with a deformation percentage of at least 15%

Blocking resistance: A coated film and an uncoated film that were each cut in a 50 mm×50 mm square form were prepared, placed over each other so as to contact the coating agent-coated surface of the coated film with one side of the uncoated film, and kept in pressure contact with each other at a pressure of 0.2 MPa at 40° C. for 24 hours. Thereafter, the two films were peeled from each other by hand, and blocking resistance was evaluated according to the following criteria:

Evaluation Criteria:

A: No blocking occurred. Excellent blocking resistance.

B: Blocking occurred to the extent that the films could be separated from each other by a gentle pull. Somewhat poor blocking resistance.

C: Strong blocking occurred. Poor blocking resistance.

The test results for the above are shown in Table 2 below.

TABLE 2

| | Example | | | | | | | |
|---|---|---|---|---|---|---|---|---|
| | 1 | 2 | 3 | 4 | 5 | 6 | 7 | 8 |
| Peel strength (mN/50 mm) | 740 | 230 | 430 | 390 | 420 | 430 | 450 | 400 |
| Deformability | A | A | A | A | A | A | A | A |
| Blocking resistance | A | A | A | A | A | A | A | A |

| | Example | | | | | Comp. Ex. | |
|---|---|---|---|---|---|---|---|
| | 9 | 10 | 11 | 12 | 13 | 1 | 2 |
| Peel strength (mN/50 mm) | 320 | 490 | 370 | 380 | 3670 | 26000 | 0 |
| Deformability | A | A | A | A | A | A | C |
| Blocking resistance | A | A | A | A | B | C | A |

From the results shown in Table 2, it is clear that the shrink label of the present invention has excellent properties in terms of removability, PET bottle deformation prevention effects, and blocking resistance.

1. A shrink label for a PET bottle comprising a heat-shrinkable film, wherein the shrink label has an adhesive coating film layer of a coating agent (A) on the side contacting the PET bottle, the adhesive coating film layer having a dry film thickness of 0.1 to 10 μm; and the peel strength after keeping the coating film surface of the shrink label and a PET film in pressure contact with each other at a pressure of 8.5 MPa in a 40° C. atmosphere for 24 hours is within the range of 5 mN/50 mm to 17 N/50 mm.

2. A shrink label according to claim 1, wherein the shrink label is for a PET bottle having a plurality of alternately projecting and sunken portions in the circumferential direction; and the shrink label having the adhesive coating film layer of the coating agent (A) on the side contacting the PET bottle, the adhesive coating film layer being provided on at least the portions contacting the projecting portions of the PET bottle.

3. A shrink label according to claim 1, wherein the heat-shrinkable film comprises a polyester resin, polystyrene resin, polyolefin resin, or polyvinyl chloride resin.

4. A shrink label according to claim 1, wherein the heat-shrinkable film has a thickness of 10 to 100 μm and a shrinkage stress of at least 2.0 N/cm in the main shrinkage direction.

5. A shrink label according to claim 1, wherein the coating agent (A) comprises an organic resin (a) having a number average molecular weight of 500 to 100,000 and a softening point of 30° C. to 150° C.

6. A shrink label according to claim 3, wherein the organic resin (a) is at least one resin selected from the group consisting of epoxy resins, acrylic resins, ethylene vinyl acetate resins, polyester resins, urethane resins, and terpene resins.

7. A shrink label according to claim 5, wherein the coating agent (A) further comprises a pigment (b).

8. A shrink label according to claim 7, wherein the pigment (b) is titanium oxide and/or aluminum powder.

9. A shrink label according to claim 1, wherein the coating film of the coating agent (A) is formed by gravure coating.

10. A shrink label according to claim 9, wherein, at the time of gravure coating, the coating agent (A) has a solids content of 20% to 80% by weight and a viscosity of 5 to 60 seconds/Zahn cup #3.

11. A shrink label according to claim 1, wherein the peel strength after keeping the coating film surface of the coating agent (A) and the PET film in pressure contact with each other at a pressure of 8.5 MPa in a 40° C. atmosphere for 24 hours is within the range of 10 mN/50 mm to 4 N/50 mm.

12. A shrink label according to claim 11, wherein the peel strength after keeping the coating film surface of the coating agent (A) and the PET film in pressure contact with each other at a pressure of 8.5 MPa in a 40° C. atmosphere for 24 hours is within the range of 50 mN/50 mm to 1 N/50 mm.

13. A PET bottle having a shrink label according to claim 1 attached thereto.
